(19) United States
(12) Patent Application Publication
(10) Pub. No.: US 2026/0212056 A1
(43) Pub. Date: Jul. 23, 2026

(54) GENERATING CLUSTERS OF CONSTRAINED CAD DRAWINGS BASED ON GEOMETRIC REGULARITY

(71) Applicant: AUTODESK, INC., San Francisco, CA (US)

(72) Inventors: Justin Frank MATEJKA, Newmarket (CA); Jeremy John MINTON, Bristol (GB); Joseph George LAMBOURNE, London (GB); George William FITZMAURICE, Toronto (CA); John Roger THOMPSON, Atlanta, GA (US)

(21) Appl. No.: 19/440,471

(22) Filed: Jan. 5, 2026

Related U.S. Application Data
(60) Provisional application No. 63/748,269, filed on Jan. 22, 2025.

(51) Int. Cl. G06F 30/12; G06F 111/04

(52) U.S. Cl. CPC G06F 30/12; G06F 2111/04

(57) ABSTRACT

A computer-implemented method for grouping constrained computer-aided design (CAD) drawings includes receiving a plurality of constrained CAD drawings; generating a plurality of geometric variations, wherein each geometric variation in the plurality of geometric variations is based on one of the constrained CAD drawings in the plurality of constrained CAD drawings; generating, for each geometric variation included in the plurality of geometric variations, a regularity graph that represents geometric regularities between a plurality of geometric elements included in the geometric variation; sorting the geometric variations based on the regularity graphs to generate a plurality of filtered constrained CAD drawings; and displaying, via a user interface, the plurality of filtered constrained CAD drawings.

### CROSS-REFERENCE TO RELATED APPLICATIONS

This application claims priority benefit of the United States Provisional Patent Application titled, “TECHNIQUES FOR CLUSTERING CONSTRAINED CAD SKETCHES USING REGULARITY CAPTURE,” filed on January 22, 2025, and having Serial No. 63/748,269. The subject matter of this related application is hereby incorporated herein by reference.

### BACKGROUND

### Field of the Various Embodiments

The various embodiments relate generally to computer science and complex software applications, and, more specifically, to generating clusters of constrained computer-aided design (CAD) drawings based on geometric regularity.

### Description of the Related Art

In the discipline of computer aided design, part of the process of generating a three-dimensional (3D) model is drafting a two-dimensional (2D) sketch or drawing. Generally, a 2D CAD drawing is made up of individual geometric elements, such as lines, arcs, circles, etc., that are positioned on a 2D surface and defined with specific dimensional values.

To facilitate the generation of a 3D model from a 2D CAD drawing, the CAD drawing is oftentimes parameterized with geometric constraints between individual geometric elements of the CAD drawing. For example, circles or arcs can be constrained to share a common centerpoint, two lines can be constrained to remain orthogonal or parallel to each other, and an end point of one line can be constrained to be collocated with an end point of another line. Thus, when suitable geometric constraints are included in a 2D CAD drawing, dimensional values and/or the locations of geometric elements can be modified and the 2D CAD drawing will be automatically scaled in a way that retains the design intent of the model represented by the 2D CAD drawing. As a result, a correctly parameterized 2D CAD drawing can be employed as the basis of a 3D model that does not deform, develop holes or discontinuous lines, or otherwise depart from the design intent when portions of the model are scaled or otherwise modified by a designer.

However, for many designers, applying geometric constraints to a 2D CAD drawing in a way that accurately captures design intent and does not overly constrain the drawing can be difficult. Such difficulty is particularly pronounced for more complex parts or designs. For example, a designer may intend to constrain a 2D CAD drawing so that one component of the design can be scaled longer or shorter in a particular direction while other elements of the design remain constant in size and do not separate from scaled components. Correctly scaling the 2D CAD drawing for such design intent requires careful selection of multiple geometric constraints, such as limiting the endpoints of specified lines to be collocated with the endpoints of specified lines, constraining certain lines to remain perpendicular to other specified lines, constraining certain points to remain stationary, and the like. Omission of even one of such constraint can lead to a 3D model that is underconstrained, has elements that do not scale correctly, and/or has unwanted distortions or discontinuous lines when one or more dimensions of the design are modified. Further, for the same 2D CAD drawing, a different design intent can require a completely different set of constraints to be applied. As a result, the process of applying suitable geometric constraints to a 2D CAD drawing can be time-consuming and generally requires significant design experience.

To facilitate the design process, automated tools known as “constraint solvers” have been developed that can apply dimensional and geometric constraints to a 2D CAD drawing. For example, various artificial intelligence (AI) based constraint solvers can analyze the geometric elements in a 2D CAD drawing and infer geometrical relationships that need to be maintained between the geometric elements, such as tangency and alignment. Because no single correct configuration of constraints exists for a given 2D CAD drawing, constraint solvers typically provide multiple possible configurations of constraints for a single 2D CAD drawing. A designer can then select a configuration from among the results provided and edit the constraints accordingly.

At least one drawback of the foregoing approach is that, when a plurality of different constraint configurations are provided to a user for a specific 2D CAD drawing, many of the configurations can cause the 2D CAD drawing to scale in a similar or identical way. This occurs because different combinations of geometric constraints can have the same effect on the scaling of a 2D CAD drawing. Thus, a user is often forced to evaluate multiple constraint configurations that all parameterize the CAD drawing to scale in the same way. As a result, a user can be limited to selecting a constraint configuration from a narrow range of options that parameterize the 2D CAD drawing in similar or identical ways. Such a limited selection of constraint configurations may fail to fully capture the design intent of the 2D CAD drawing, which can lead to inaccurate or otherwise unacceptable results.

Another drawback of the foregoing approach is that the foregoing approach results in inefficient use of processing resources. Such a drawback arises from the large number of mathematically valid constraint configurations that can be generated for a single 2D CAD drawing. Because conventional systems lack automated mechanisms for providing a selection of constraint configurations that each scale the 2D CAD drawing in different ways, a user can oftentimes be provided with no constraint configuration that retains the design intent of the 2D CAD drawing. As a result, a user may be forced to request and evaluate multiple sets of constraint configurations for a single 2D CAD drawing, requiring repeated constraint computations. Constraint computations generally include artificial intelligence-powered and other computationally intensive processes, and employing such processes repeatedly to accomplish a single task in this way is an inefficient use of computational resources.

As the foregoing illustrates, what is needed in the art are more effective techniques for providing constraint configurations to a user for a 2D CAD drawing that include a range of parameterization behaviors.

### SUMMARY

A computer-implemented method for grouping constrained computer-aided design (CAD) drawings includes receiving a plurality of constrained CAD drawings; generating a plurality of geometric variations, wherein each geometric variation in the plurality of geometric variations is based on one of the constrained CAD drawings in the plurality of constrained CAD drawings; generating, for each geometric variation included in the plurality of geometric variations, a regularity graph that represents geometric regularities between a plurality of geometric elements included in the geometric variation; sorting the geometric variations based on the regularity graphs to generate a plurality of filtered constrained CAD drawings; and displaying, via a user interface, the plurality of filtered constrained CAD drawings.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques provide a designer or other user with constraint configurations for a specific 2D CAD drawing, where each constraint configuration causes the 2D CAD drawing to scale in a different way. Thus, a user can select a constraint configuration from a wide range of options that parameterize the 2D CAD drawing in a variety of ways and is not forced to evaluate many constraint configurations that are isometrically identical to one another. Consequently, the user is more likely to identify a constraint configuration that fully captures the design intent of the 2D CAD drawing.

Another advantage is that processing resources are more efficiently utilized in providing a suitable constraint configuration to a user. Such efficiency arises because the disclosed techniques provide automated mechanisms for providing a selection of constraint configurations, where each constraint configuration is more likely to cause the 2D CAD drawing to scale differently when parametric values are modified. Therefore, repeated computation to generate additional constraint configurations can be avoided. Further, in some embodiments, the use of a previously evaluated constraint configuration can be employed for a 2D CAD drawing in lieu of generating and evaluating a plurality of constraint configurations. In such embodiments, a cached constraint configuration that is topologically equivalent to the 2D CAD drawing can be employed for the 2D CAD drawing, thereby avoiding the computations needed to generate a plurality of new constraint configurations for the 2D CAD drawing with a constraint solver. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 conceptually illustrates a constraint configuration clustering system, according to various embodiments.

FIG. 2 sets forth a flowchart of method steps for clustering constrained CAD drawings into related families, according to various embodiments.

FIG. 3 is a conceptual illustration of a 2D CAD drawing, according to various embodiments.

FIG. 4 is a conceptual illustration of a constraint configuration for the 2D CAD drawing of FIG. 3, according to various embodiments.

FIG. 5 is a conceptual illustration of a plurality of geometric variations for a constraint configuration, according to various embodiments.

FIG. 6 conceptually illustrates a partially constructed regularity graph, according to various embodiments.

FIG. 7 conceptually illustrates a partially constructed regularity graph that includes horizontal alignments detected in a geometric variation of interest, according to various embodiments.

FIG. 8 conceptually illustrates a partially constructed regularity graph that includes vertical alignments detected and horizontal lines detected in a geometric variation of interest, according to various embodiments.

FIG. 9 sets forth a flowchart of method steps for selecting a constrained CAD drawings based on a hash value, according to various embodiments.

FIG. 10 is a block diagram of a computing device configured to implement one or more aspects of the various embodiments.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

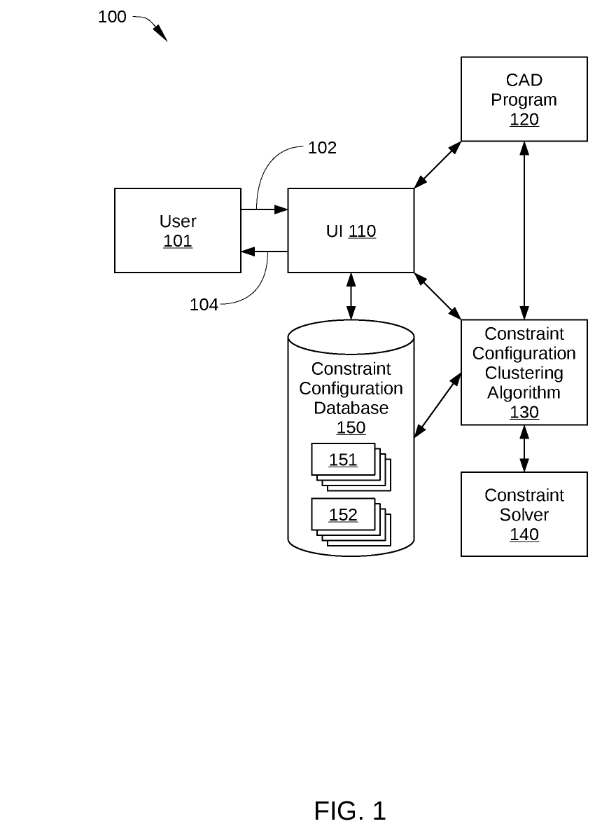

FIG. 1 conceptually illustrates a constraint configuration clustering system 100, according to various embodiments. Constraint configuration clustering system 100 is configured to facilitate the selection of a constraint configuration for a particular two-dimensional (2D) computer-aided design (CAD) drawing, for example from a plurality of suggested constraint configurations that are provided by a constraint solver 140. In operation, constraint configuration clustering system 100 provides a designer or other user 101 with a plurality of different constraint configurations (or groupings of similar constraint configurations) that each affect a 2D CAD drawing differently when applied to the 2D CAD drawing. Thus, each of the constraint configurations (or groupings of constraint configurations) provided to user 101 causes the 2D CAD drawing to scale differently. As a result, user 101 is more likely to be provided with at least one constraint configuration that captures the specific design intent of user 101 for the 2D CAD drawing. In the embodiment shown in FIG. 1, constraint configuration clustering system 100 includes a user interface 110, a CAD program 120, a constraint configuration clustering algorithm 130, a constraint solver 140, and a constraint configuration database 150.

User interface (UI) 110 enables a user to provide inputs 102 to constraint configuration clustering system 100 and to view or otherwise receive outputs 104 from constraint configuration clustering system 100, for example via suitable input/output (I/O) devices. For example, in some embodiments, UI 110 includes a graphical user interface (GUI) that is displayed via a suitable display device. Alternatively, or additionally, in some embodiments, UI 110 includes a command-line interface that enables a user to interact with constraint configuration clustering system 100 via typed commands and text-based output. In some embodiments, the command-line interface can be a terminal window or another text-based window within a GUI. Thus, in some embodiments, inputs 102 and/or outputs 104 can be graphical and/or text-based.

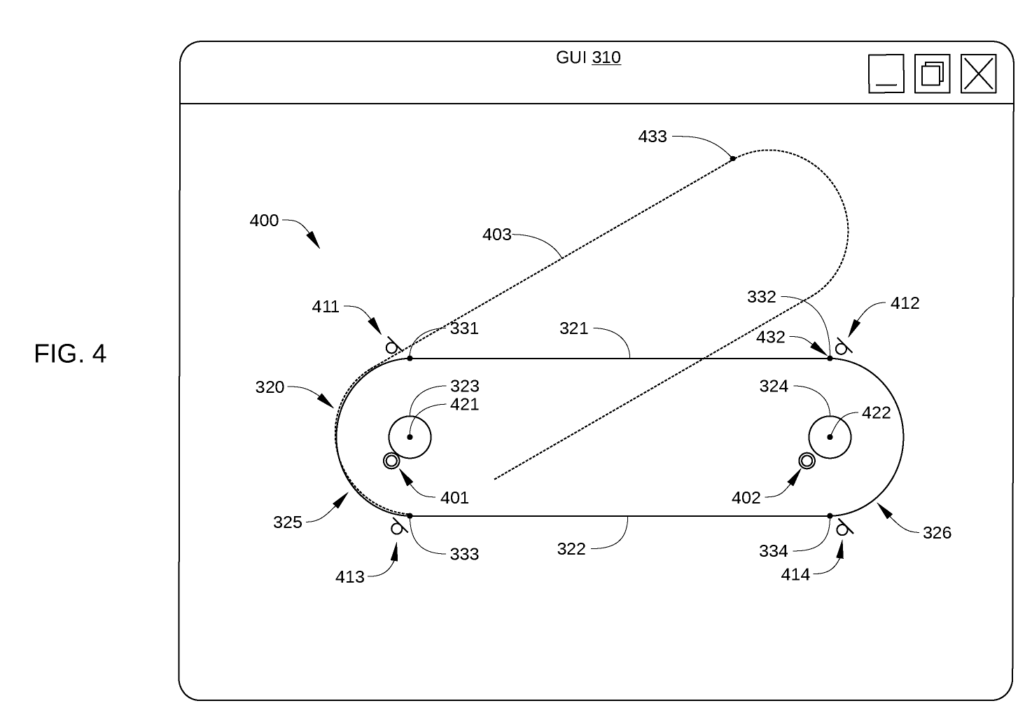

Inputs 102 can include a 2D CAD drawing of a design object, such as an article of manufacture, a mechanism, a component of a mechanism, and the like. Inputs 102 can further include user selections or other interactions with CAD program 120 and/or constraint configuration clustering algorithm 130, such as the selection of a specific constraint configuration for evaluation or implementation. In some embodiments, inputs 102 can include a plurality of different constraint configurations for the 2D CAD drawing, for example in lieu of using constraint solver 140 to generate the different constraint configurations for the 2D CAD drawing. Embodiments of a constraint configuration are described in greater detail below in conjunction with FIG. 4.

The 2D CAD drawing included in inputs 102 comprises multiple individual geometric elements, such as lines, arcs, circles, and the like, which are positioned on a digital 2D surface and defined with specific dimensional values. In some embodiments, the 2D CAD drawing is generated using CAD program 120, while in other embodiments, the 2D CAD drawing is generated using any other suitable software program and is then input by user 101. As part of a design process, the 2D CAD drawing can be employed as the basis of a three-dimensional (3D) model of the design object. However, to ensure that the design intent of the design object in the 2D CAD drawing is retained in the 3D model, suitable geometric constraints can be included in the 2D CAD drawing. Such geometric constraints cause the geometric elements of the 2D CAD drawing to be scaled in a way that retains the design intent of the design object represented by the 2D CAD drawing. Thus, when a designer modifies dimensional values and/or the locations of geometric elements in a suitably constrained 2D CAD drawing, certain components of the design object scale to be longer or shorter and/or undergo rotation as desired. In addition, in a suitably constrained 2D CAD drawing, modification of dimensional values and/or the locations of geometric elements does not cause discontinuous lines to appear in the design object and does not cause unwanted deformation of the design object in a way that violates the design intent of the design object. Some or all of the geometric constraints for the 2D CAD drawing can be determined by constraint solver 140 as described below and/or provided as inputs 102. In some embodiments, one or more geometric constraints for the 2D CAD drawing can be included manually by user 101, for example as inputs 102 to CAD program 120.

Outputs 104 can include a 2D CAD drawing, for example generated via CAD program 120. Outputs 104 can also include one or more constraint configurations generated for a specific 2D CAD drawing by constraint solver 140. Each constraint configuration is a constrained version of the 2D CAD drawing and includes a unique combination of one or more geometric constraints. In a constrained version of a 2D CAD drawing, modifications are subject to the combination of geometric constraints included in the particular constrained version of the 2D CAD drawing. For example, changes to dimensional values and/or the locations of geometric elements in the constrained version of the 2D CAD drawing are limited by the geometric constraints included in the particular constrained version of the 2D CAD drawing. In some embodiments, each geometric constraint is indicated in a constraint configuration with an icon or glyph. Examples of geometric constraints that can be included in a constraint configuration include tangency of a line to an arc or circle, alignment of one geometric element with another geometric element, perpendicularity of one geometric element to another geometric element, parallelism of one geometric element with another geometric element, colocation of a center point of one arc or circle with a center point of another arc or circle, colocation of a point on one geometric element with a point on another geometric element, symmetry of two or more objects about a line, and the like.

According to various embodiments, outputs 104 can further include multiple groups, or "clusters," of similar constraint configurations for a particular 2D CAD drawing, where each constraint configuration cluster generally causes the 2D CAD drawing to scale differently when applied to the 2D CAD drawing. Thus, when a large number of constraint configurations are available for a particular 2D CAD drawing, constraint configuration clustering system 100 organizes the large number of constraint configurations into multiple constraint configuration clusters that can each capture a different design intent for the 2D CAD drawing. In such embodiments, outputs 104 can include one representative constraint configuration that is displayed for each cluster of similar constraint configurations or isomorphically identical constraint configurations.

CAD program 120 can be any computer-aided design software configured to generate, modify, and analyze 2D drawings and 3D models. Examples of such software include AutoCAD, Fusion, and Inventor, which are available from Autodesk. Constraint solver 140 can be any software application configured to determine geometric constraints for a set of geometric objects included in a 2D CAD drawing. In some embodiments, constraint solver 140 includes a generative artificial intelligence (AI) model. Examples of such constraint solvers include LGS 2D/3D available from Ledas, D-Cubed 2D DCM available from Siemens, and C3D Solver available from C3D Labs. In some embodiments, constraint solver 140 can be implemented as functionality included in CAD program 120.

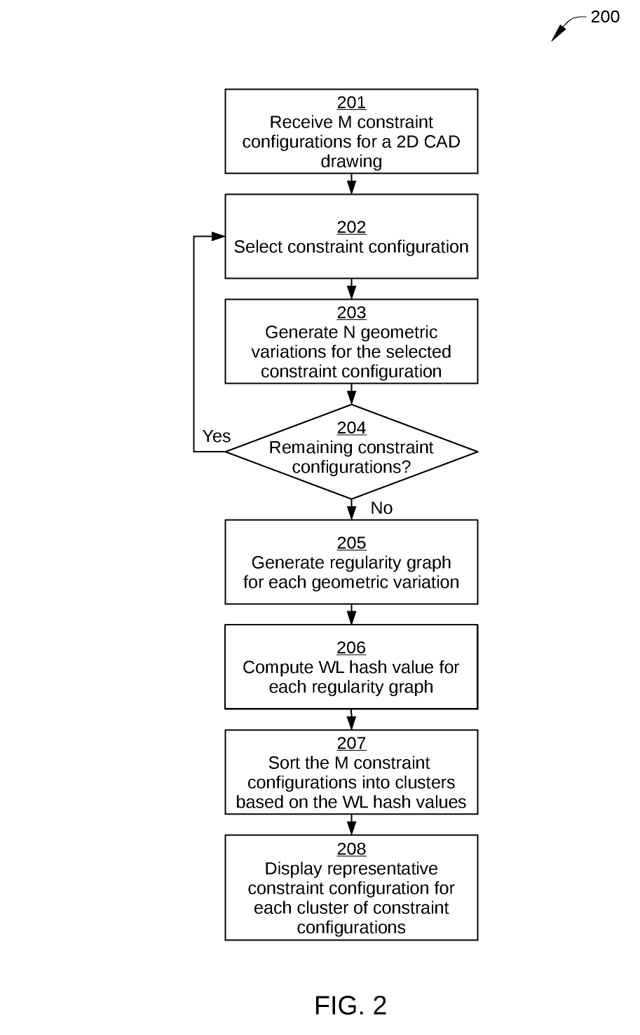

Constraint configuration database 150 stores previously evaluated constraint configurations 151 and associated hash values 152. Each previously evaluated constraint configuration 151 can be a constraint configuration for a 2D CAD drawing that has been determined to capture a useful design intent of the 2D CAD drawing. According to various embodiments, each previously evaluated constraint configuration 151 is associated with a unique hash value 152. In such embodiments, the unique hash value 152 for a previously evaluated constraint configuration 151 can be a hash value for the previously evaluated constraint configuration 151 that is generated by a Weisfeiler-Leman (WL) graph isomorphism test, as described below in conjunction with FIG. 2.

According to various embodiments, constraint configuration clustering algorithm 130 provides user 101 with a plurality of different constraint configurations (or groupings of similar constraint configurations), where each constraint configuration (or grouping of constraint configurations) affects a 2D CAD drawing differently when applied to the 2D CAD drawing. User 101 can then evaluate which specific constraint configuration best retains a specific design intent of the 2D CAD drawing when the specific constraint configuration is applied to the 2D CAD drawing.

In some embodiments, constraint configuration clustering algorithm 130 receives a first plurality of constrained CAD drawings that have been generated for a 2D CAD drawing of interest, for example via CAD program 120. In some embodiments, constraint configuration clustering algorithm 130 generates a second plurality of geometric variations of the 2D CAD drawing of interest. In such embodiments, each geometric variation is based on a constrained CAD drawing in the first plurality of constrained CAD drawings and shows a modified version of the constrained CAD drawing. In the modified version of the constrained CAD drawing, a value for at least one dimension associated with a particular geometric element included in the constrained CAD drawing is changed from an initial value to a scaled value.

In some embodiments, constraint configuration clustering algorithm 130 generates a regularity graph for each geometric variation included in the second plurality of geometric variations. In such embodiments, the regularity graph represents geometric regularities between the geometric elements included in the corresponding geometric variation, such as the presence of horizontally or vertically aligned points, horizontally or vertically aligned lines, arcs or circles having equal radii, lines being parallel to each other, lines being perpendicular to each other, arcs or circles being concentrically positioned, and the like.

In some embodiments, constraint configuration clustering algorithm 130 sorts, or “clusters,” the geometric variations based on the regularity graphs to generate a third plurality of filtered constrained CAD drawings. In such embodiments, constraint configuration clustering algorithm 130 can filter the geometric variations by applying a Weisfeiler-Lehman hash against the regularity graphs. In some embodiments, constraint configuration clustering algorithm 130 displays or causes to be displayed the third plurality of filtered constrained CAD drawings, where each filtered constrained CAD drawing affects the scaling of the 2D CAD drawing differently. Various embodiments of the operations of constraint configuration clustering algorithm 130, including how regularity graphs are constructed, are described below in conjunction with FIG. 2.

### Generation of Clusters of Constrained CAD Drawings

FIG. 2 sets forth a flowchart of method steps for clustering constrained CAD drawings into related families, according to various embodiments. Although the method steps are described in conjunction with the system of FIG. 1, persons skilled in the art will understand that any suitable system configured to perform the method steps in any order is within the scope of the embodiments.

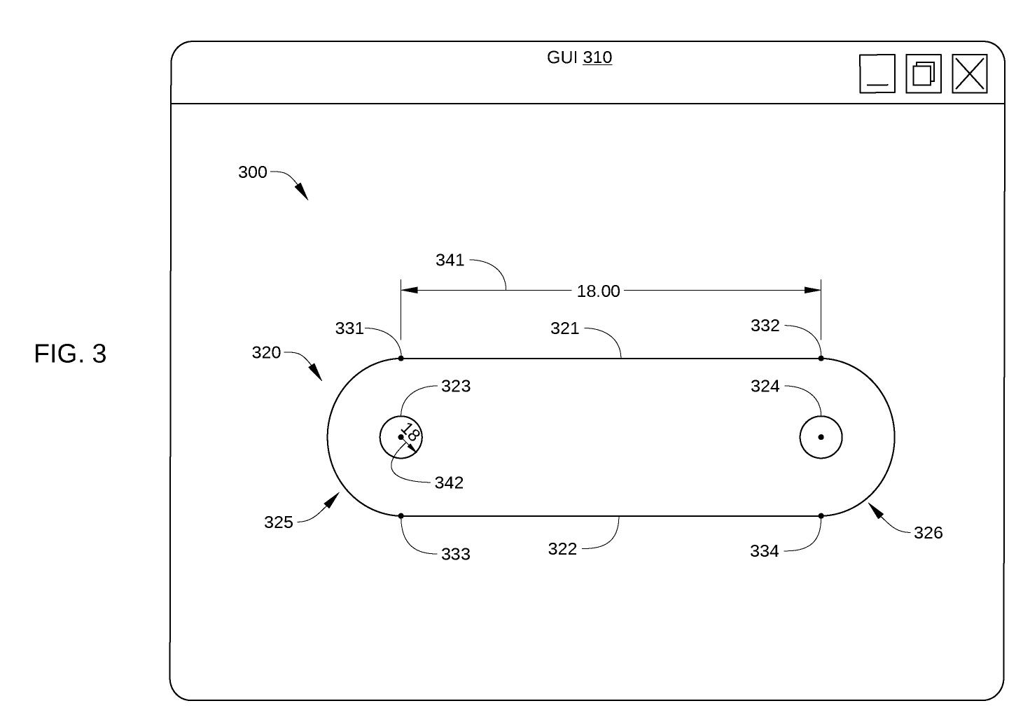

Prior to the method, a 2D CAD drawing is generated, for example via CAD program 120. Alternatively, the 2D CAD drawing can be generated via any other suitable software program. For example, user 101 can generate the 2D CAD drawing by positioning a plurality of individual geometric elements (such as lines, arcs, circles, and the like) on a 2D digital surface. In some embodiments, some or all of the geometric elements are further defined with specific dimensional values input by user 101. One embodiment of a 2D CAD drawing is described below in conjunction with FIG. 3.

FIG. 3 is a conceptual illustration of a 2D CAD drawing 300, according to various embodiments. In FIG. 3, 2D CAD drawing 300 is shown displayed by a GUI 310, such as a GUI associated with UI 110 of constraint configuration clustering system 100. 2D CAD drawing 300 includes a design object 320 that includes a plurality of geometric elements. In the embodiment illustrated in FIG. 3, the geometric elements include a top surface 321 represented by a horizontal line, a bottom surface 322 represented by another horizontal line, a first hole 323 represented by a circle, a second hole 324 represented by a second circle, a first end surface 325 represented by a first arc, and a second end surface 326 represented by a second arc. As shown, in the embodiment illustrated in FIG. 3, top surface 321 is connected to first end surface 325 at a point 331 and to second end surface 326 at a point 332, while bottom surface 322 is connected to first end surface 325 at a point 333 and to second end surface 326 at a point 334. Further, a dimension 341 is assigned a value of 160 units for top surface 321 and bottom surface 322, while a radius 342 of first hole 323 and second hole 324 is assigned a value of 18 units. In some embodiments, additional dimensional values can be assigned to other features of design object 320.

Returning to FIG. 2, a computer-implemented method 200 begins at step 201, where constraint configuration clustering algorithm 130 receives a plurality (e.g., M) of different constraint configurations for the 2D CAD drawing generated prior to step 201. For example, in some embodiments, user 101 provides the M different constraint configurations for the 2D CAD drawing to constraint configuration clustering algorithm 130 via UI 110. Alternatively, in some embodiments, constraint configuration clustering system 100 generates the M constraint configurations based on the 2D CAD drawing, for example via constraint solver 140. Each of the M constraint configurations is a constrained version of the 2D CAD drawing that includes a unique combination of one or more geometric constraints. Thus, each constraint configuration received or generated in step 201 is a constrained version of the 2D CAD drawing generated prior to step 201. One embodiment of a constraint configuration for a 2D CAD drawing is described below in conjunction with FIG. 4.

FIG. 4 is a conceptual illustration of a constraint configuration 400 for a 2D CAD drawing, according to various embodiments. Constraint configuration 400 is a constrained version of the 2D CAD drawing generated prior to step 201. For ease of description, in the embodiment illustrated in FIG. 4, the 2D CAD drawing generated prior to step 201 is assumed to be consistent with 2D CAD drawing 300 of FIG. 3. Thus, in the embodiment illustrated in FIG. 4, constraint configuration 400 includes design object 320 with top surface 321, bottom surface 322, first hole 323, second hole 324, first end surface 325, and second end surface 326 positioned as shown. In some embodiments, the 2D CAD drawing can have any other configuration and can include more, fewer, or different geometric elements than the geometric elements shown in FIG. 4.

In FIG. 4, constraint configuration 400 further includes a set of multiple geometric constraints, including two concentric constraints 401 and 402 and four tangential constraints 411 – 414. In the embodiment illustrated in FIG. 4, concentric constraint 401 indicates that the circle representing first hole 323 and the arc representing first end surface 325 share a common center point 421, while concentric constraint 402 indicates that the circle representing second hole 324 and the arc representing second end surface 326 share a common center point 422. Tangential constraint 411 indicates that top surface 321 connects tangentially to first end surface 325 at point 331, tangential constraint 412 indicates that top surface 321 connects tangentially to second end surface 326 at point 332, tangential constraint 413 indicates that bottom surface 322 connects tangentially to first end surface 325 at point 333, and tangential constraint 414 indicates that bottom surface 322 connects tangentially to second end surface 326 at point 334. Thus, in the embodiment illustrated in FIG. 4, constraint configuration 400 corresponds to a highly constrained 2D drawing. As a result, editing design object 320 by, for example, changing a location of point 332 from an initial location 432 to a modified location 433 results in design object 320 maintaining an original obround shape and thus rotating about center point 421 of first hole 323 to modified location 403 (dashed lines). In an instance in which constraint configuration 400 includes fewer geometric constraints than geometric constraints 401, 402, and 411 – 414 illustrated in FIG. 4, editing of design object 320 may result in the overall shape of design object 320 deforming from the original obround shape shown.

The multiple geometric constraints of constraint configuration 400 define and enforce certain design relationships between the geometric objects (e.g., arc, circles, and lines) of design object 320, such as maintaining lines that are parallel, perpendicular, or coincident, maintaining center points of multiple arcs or circles that are coincident, and similar design relationships. Such design relationships are maintained by the geometric constraints of constraint configuration 400 even when the geometric objects included in design object 320 are edited.

As noted previously, one or more of the geometric constraints of constraint configuration 400 can be included in constraint configuration 400 by user 101 when initially generating design object 320. Alternatively, or additionally, some or all of the geometric constraints of constraint configuration 400 can be included in constraint configuration 400 by constraint solver 140 prior to computer-implemented method 200.

Returning to FIG. 2, in step 202, constraint configuration clustering algorithm 130 selects a constraint configuration from the M constraint configurations. In step 203, constraint configuration clustering algorithm 130 generates a set of M geometric variations for the constraint configuration selected in step 202. According to various embodiments, each geometric variation represents the geometric elements of a 2D CAD drawing in which a value for at least one dimension or point location associated with a geometric element included in the 2D CAD drawing is changed from an initial value to a scaled value. Thus, each such geometric variation is a scaled, moved, or otherwise modified version of the constraint configuration selected in step 202 that indicates some of the behavior of the selected constraint configuration when scaled by a modified parameter value.

In some embodiments, the dimension associated with the particular geometric element can be one of a length of the particular geometric element, a radius of the particular geometric element, a vertical position within the indicated constraint configuration 400 of a point on the particular geometric element, or a horizontal position within the indicated constraint configuration 400 of the point on the particular geometric element. For example, one geometric variation can be a representation of design object 320 after being edited so that a radius of a geometric element is increased or decreased slightly from an initial value.

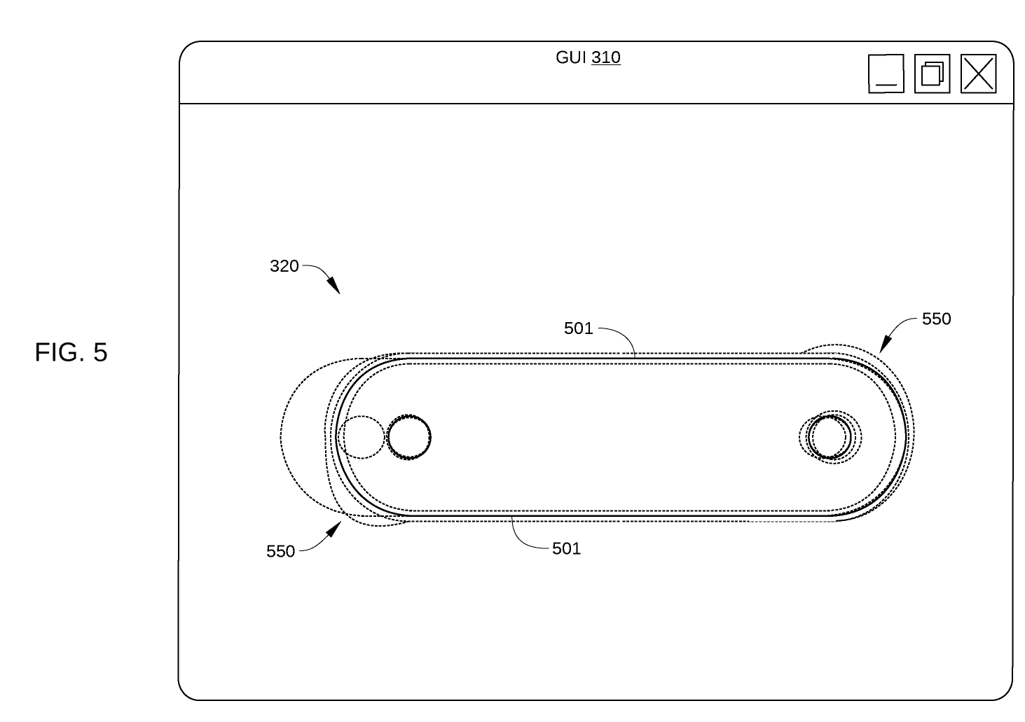

When M is a suitably large value, the M geometric variations can indicate the overall behavior of the selected constraint configuration when scaled in some way by user 101. Taken together, the M geometric variations can indicate whether the selected constraint configuration correctly captures the design intent for the 2D CAD drawing. In some embodiments, the value of M is selected to be greater than or equal to the number of geometric elements included in the 2D CAD drawing associated with the selected constraint configuration. In some embodiments, the value of M is selected to be greater than or equal to the number of parametric values (dimensions, locations, and the like) for the geometric elements included in the 2D CAD drawing associated with the selected constraint configuration. Embodiments of the geometric variations of a particular constraint configuration are described in greater detail below in conjunction with FIG. 5.

FIG. 5 is a conceptual illustration of a plurality of geometric variations 550 for a constraint configuration, according to various embodiments. As shown, an initial state 501 (solid line) of a design object is shown as well as a plurality of geometric variations 550 (dashed lines). Initial state 501 of the design object corresponds to the design object (e.g., design object 320 of FIG. 3) having the dimensions and point locations indicated in the 2D CAD drawing generated prior to step 201. Each geometric variation 550 represents an instance of one or more dimensions or point locations being modified from an initial value. Thus, in some embodiments, a geometric variation 550 is generated by varying one or more dimensions of the selected constraint configuration.

In some embodiments, constraint configuration clustering algorithm 130 generates a geometric variation 550 by selecting at least one dimension associated with one particular geometric element in the constraint configuration, determining a scaled value for the at least one dimension, and rendering a representation of the constraint configuration in which an initial value of the at least one dimension is changed to the scaled value. It is noted that constraint configuration clustering algorithm 130 renders the representation of the constraint configuration by applying the scaled value for the at least one dimension as well as the geometric constraints associated with the constraint configuration. Thus, each geometric variation 550 takes into account the constraints associated with the corresponding constraint configuration.

It is noted that in the embodiment illustrated in FIG. 5, the M geometric variations 550 indicate that the selected constraint configuration for which geometric variations 550 are generated is relatively unconstrained, because most or all of the M geometric variations 550 show significant deformation of design object 320. By contrast, in an embodiment in which the selected constraint configuration is fully constrained and aligned with the intent of a designer, each of the M geometric variations 550 will scale in a predictable way - in this case showing no deformation and scaling uniformly

Returning to FIG. 2, in step 204, after the M geometric variations 550 are generated for the selected constraint configuration, constraint configuration clustering algorithm 130 determines whether there are any remaining constraint configurations for the 2D CAD drawing for which geometric variations 550 are to be generated. If yes, computer-implemented method 200 returns to step 202 and another of the M constraint configurations is selected; if no, computer-implemented method 200 proceeds to step 205.

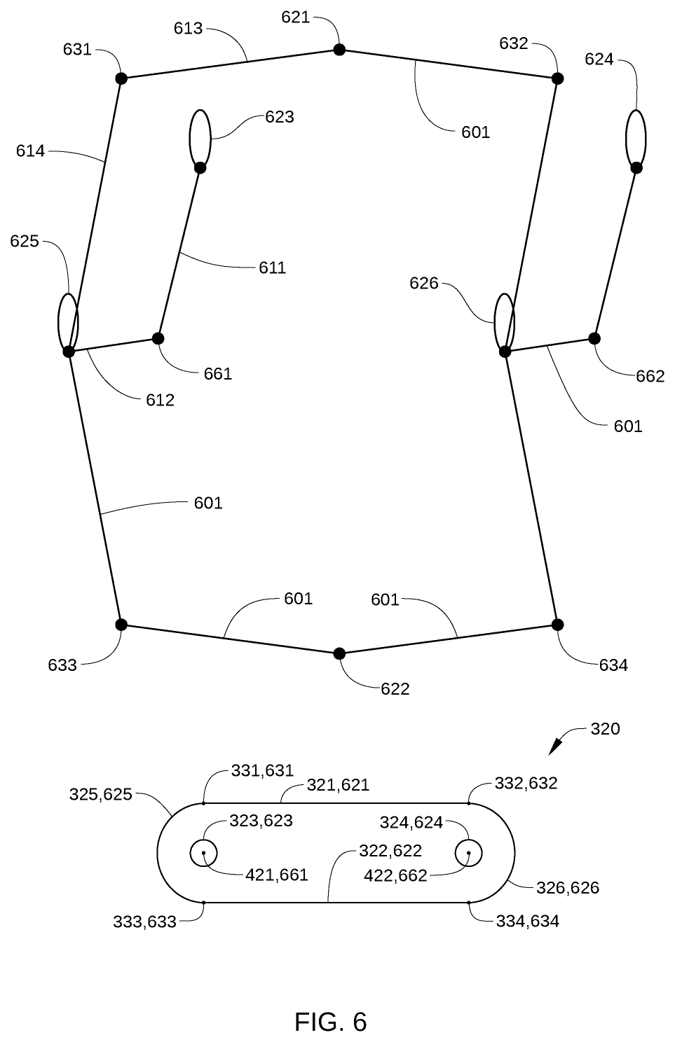

In step 205, constraint configuration clustering algorithm 130 generates a regularity graph for each of the M x N geometric variations 550 generated in steps 202 – 204. A regularity graph is a mathematical structure that represents the geometric regularities between the geometric elements of a specific constraint configuration. Specifically, a regularity graph is an undirected graph built from captured geometric regularities in a particular constraint configuration. It is noted that, in some instances, such geometric regularities are the result of the constraints and dimensions present in the sketch. However, constraints and dimensions are not explicitly included in a regularity graph. In some embodiments a regularity graph for each geometric variation 550 is created by detecting relationships between geometries that are consistent with constraints. It is noted that a complete set of regularities for a particular geometric variation 550 is not applied as constraints because that particular geometric variation 550 would then be over-constrained. The construction of a partial regularity graph is described below in conjunction with FIGS. 6-8.

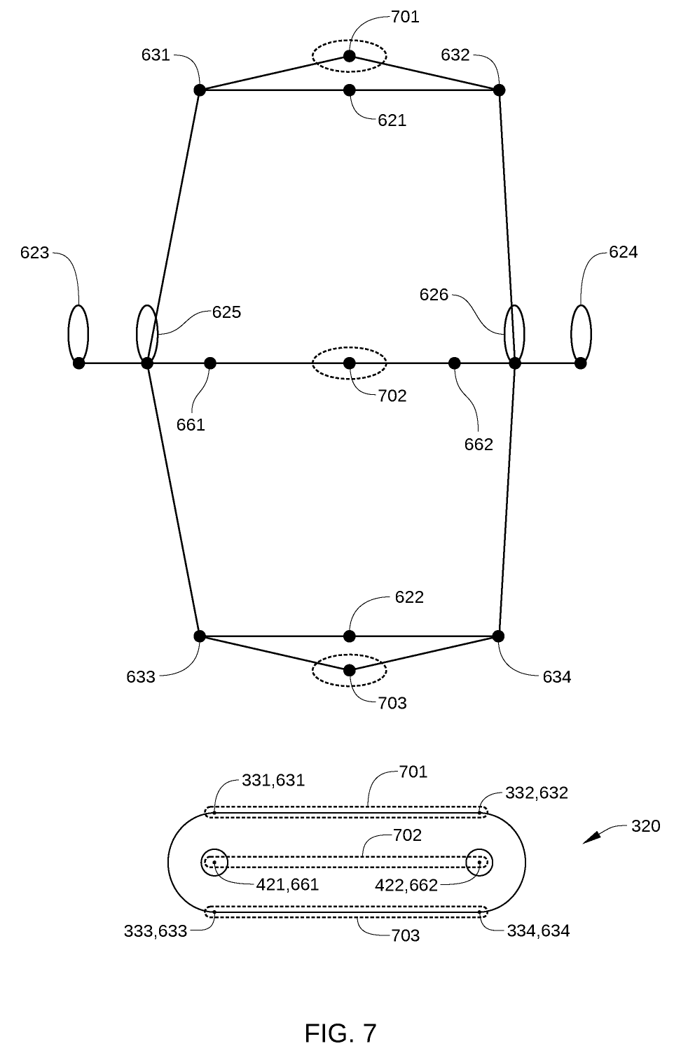

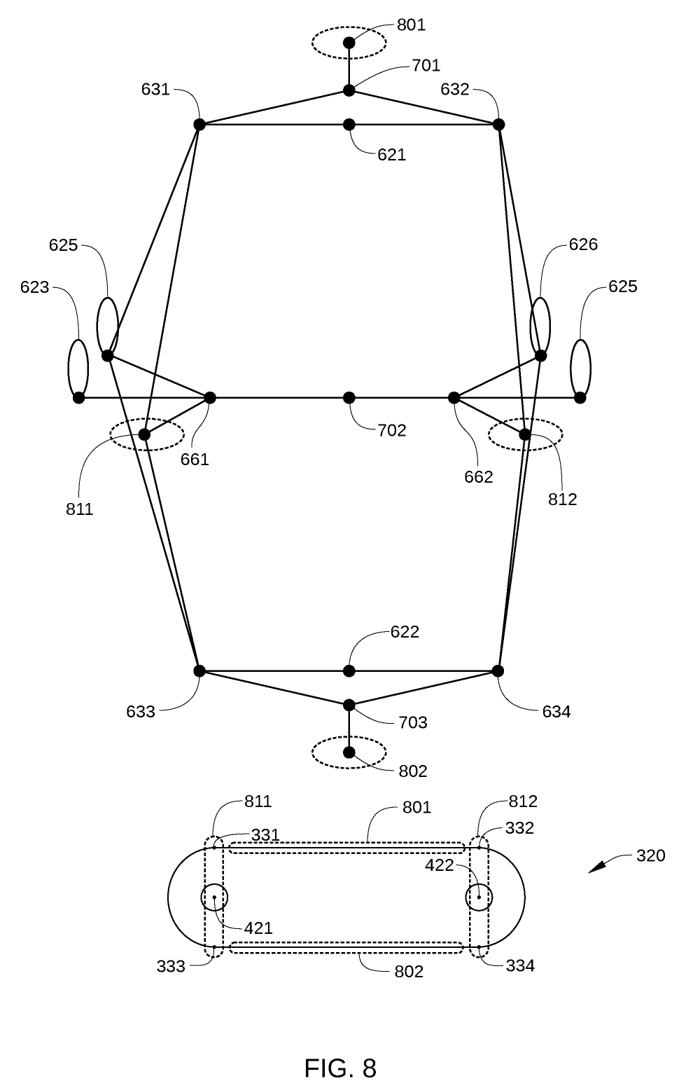

FIG. 6 conceptually illustrates a partially constructed regularity graph 600, according to various embodiments. In the embodiment illustrated in FIG. 6, partially constructed regularity graph 600 represents the geometric elements of a particular geometric variation of a constraint configuration, such as lines, points, and curves. Subsequently, the geometric relationships between the geometric elements are also added to partially constructed regularity graph 600, as shown in FIGS. 7 and 8. Once a regularity graph is completely constructed, a regularity hash is computed as described below.

It is noted that partially constructed regularity graph 600 does not include information about the coordinate positions or parameter values, such as dimensions, of the geometric elements of the particular geometric variation. Such omission occurs because dimensional positions and values are irrelevant to the herein described isomorphism analysis performed by constraint configuration clustering algorithm 130.

Instead, relative comparisons between geometric elements (e.g., horizontal or vertical alignment, equivalence, and the like) affect the makeup of partially constructed regularity graph 600.

In the embodiment illustrated in FIG. 6, the geometric variation on which partially constructed regularity graph 600 is based is consistent with 2D CAD drawing 300 of FIG. 3. Thus, in FIG. 6, partially constructed regularity graph 600 represents design object 320, which has top surface 321, bottom surface 322, first hole 323, second hole 324, first end surface 325, and second end surface 326. For reference, the specific version of design object 320 on which partially constructed regularity graph 600 is based is also shown in FIG. 6. Further, for each geometric element of design object 320, the corresponding node label is also shown. Thus, in FIG. 6, top surface 321 of design object 320 is also labeled with 621, which is the corresponding node of partially constructed regularity graph 600, point 331 is also labeled 631, which is the corresponding node of partially constructed regularity graph 600, point 332 is also labeled 632, which is the corresponding node of partially constructed regularity graph 600, and so on.

In partially constructed regularity graph 600, each node corresponds to a specific geometric element (e.g., a point, curve, or line) in design object 320. By contrast, each edge in partially constructed regularity graph 600 corresponds to a geometric connection or relationship between the two geometric elements connected by the edge. Thus, in the embodiment illustrated in FIG. 6, partially constructed regularity graph 600 includes nodes 631 – 634 that respectively represent points 331 – 334 of design object 320, nodes 621 and 622 that respectively represent top surface 321 and bottom surface 322 of design object 320, nodes 661 and 662 that respectively represent center point 421 and center point 422 of design object 320, nodes 623 and 624 that respectively represent first hole 323 and second hole 324 of design object 320, and nodes 625 and 626 that respectively represent first end surface 325 and second end surface 326 of design object 320. Partially constructed regularity graph 600 further includes a plurality of edges 601 that indicate a geometric connection or relationship between the two geometric elements. For example, an edge 611 connects node 661 (representing center point 421) to node 623 (representing the circle first hole 323), thereby indicating that the center point of first hole 323 is center point 421. In another example, an edge 612 connects node 661 (representing center point 421) to node 625 (representing the arc that forms first end surface 325), thereby indicating that the center point of the arc that forms first end surface 325 is also center point 421. Similarly, an edge 613 connects node 631 (representing point 331) to node 621 (representing top surface 321), thereby indicating that an end point of top surface 321 is point 331. Further, an edge 614 connects node 631 (representing point 331) to node 625 (representing the arc that forms first end surface 325), thereby indicating that an end point of first end surface 325 is also point 331.

In some embodiments, after the geometric elements of the design object in the geometric variation of interest are included in a regularity graph, geometric regularities are detected in the geometric variation. For example, in some embodiments, horizontal alignment of two or more points in the geometric variation is searched for. In such embodiments, the horizontal alignments that are detected are then included in the regularity graph. The addition of detected horizontal alignments to a regularity graph is described below in conjunction with FIG. 7. In another example, the presence of horizontal lines and/or the vertical alignment of two or more points in the geometric variation is searched for. In such embodiments, the horizontal lines and vertical alignments that are detected are then included in the regularity graph. The addition of detected vertical alignments and horizontal lines to a regularity graph is described below in conjunction with FIG. 8.

FIG. 7 conceptually illustrates a partially constructed regularity graph 700 that includes horizontal alignments detected in a geometric variation of interest, according to various embodiments. In the embodiment illustrated in FIG. 7, partially constructed regularity graph 700 is consistent with partially constructed regularity graph 600 in FIG. 6, except that partially constructed regularity graph 700 also includes representations of one or more instances of detected horizontal alignments of points within a geometric variation of a 2D CAD drawing.

In the embodiment illustrated in FIG. 7, multiple instances of horizontally aligned points are detected in design object 320 and included in partially constructed regularity graph 700. Specifically, a node 701 is added to represent the horizontal alignment of points 331 and 332 in design object 320, a node 702 is added to represent the horizontal alignment of center point 421 and center point 422 in design object 320, and a node 703 is added to represent the horizontal alignment of points 333 and 334 in design object 320.

FIG. 8 conceptually illustrates a partially constructed regularity graph 800 that includes vertical alignments detected and horizontal lines detected in a geometric variation of interest, according to various embodiments. In the embodiment illustrated in FIG. 8, partially constructed regularity graph 800 is consistent with partially constructed regularity graph 700 in FIG. 7, except that partially constructed regularity graph 800 also includes representations of one or more instances of detected vertical alignments of points and detected horizontal lines within a geometric variation of a 2D CAD drawing.

In the embodiment illustrated in FIG. 8, multiple instances of vertically aligned points are detected in design object 320 and included in partially constructed regularity graph 800. Specifically, a node 801 is added to represent the horizontal line between points 331 and 332 in design object 320, and a node 802 is added to represent the horizontal line between points 333 and 334 in design object 320. In addition, a node 811 is added to represent the vertical alignment of point 331, point 333, and center point 421 in design object 320, and a node 812 is added to represent the vertical alignment of point 332, point 334, and center point 422 in design object 320. Appropriate edges are also added to indicate the above-described relationships in partially constructed regularity graph 800.

To more accurately capture the topological properties of a geometric variation of interest, additional categories of geometric regularities can be searched for and included in a regularity graph when detected. For example, in some embodiments, value-based regularities can be searched for and added to the regularity graph, such as equivalent radii of arcs and circles when within a specified tolerance. Other examples of categories of geometric regularities that can be searched for in a geometric variation and included in a regularity graph include vertically aligned lines in the geometric variation, multiple parallel lines in the geometric variation, a pair of perpendicular lines in the geometric variation, multiple concentric arcs or circles in the geometric variation, a tangency of a line to an arc or circle in the geometric variation, a pair of equidistant point-to-point distances in the geometric variation, or a pair of equidistant point-to-line distances in the geometric variation, among others.

It is noted that the geometric regularities of a particular geometric variation do not describe how the 2D CAD drawing corresponding to the particular geometric variation moves or scales when edited by a designer. However, as a complete regularity graph, the geometric regularities of a geometric variation indicate higher-level geometric concepts, such as symmetry, vertical alignment, and the like. Thus, the regularity graph of a geometric variation provides a flexible way to geometrically represent the uniformity of the geometric variation, even though coordinates, dimensions, and other parameter values are not included.

Returning to FIG. 2, in step 206, after the regularity graphs for each of the M x N geometric variations have been generated, constraint configuration clustering algorithm 130 computes a Weisfeiler-Lehman hash for each of the M x N regularity graphs generated in step 205. In graph theory, the Weisfeiler-Leman graph isomorphism test is a heuristic test for the existence of an isomorphism between two graphs and is based on a hash that is computed for each graph. Generally, in the Weisfeiler-Leman (WL) graph isomorphism test, hashes are identical for isomorphic graphs, and there is a strong guarantee that non-isomorphic graphs will each have a different hash. In the WL graph isomorphism test, a WL function iteratively aggregates and hashes neighborhoods of each node of a graph, such as a regularity graph described above. After each neighbor of a node is hashed to obtain updated node labels, a hashed histogram of resulting labels is returned as the final hash for the graph. It is noted that similarity between the hashes of two graphs does not imply any similarity between the two graphs.

In embodiments in which a network implementation of the graph hashing algorithm is employed, “labels” are set on each node and edge of a regularity graph. Each edge of a particular regularity graph is labelled (e.g., colored) according to the constraint type consistent with that geometric regularity. Geometric regularities that are applied to a single node in the particular regularity graph (for example horizontal and vertical regularities) are applied as node labels. In such embodiments, such node labels can be provided as strings, and the Weisfeiler-Lehman algorithm is then used to create the hash value for that particular regularity graph.

In step 207, constraint configuration clustering algorithm 130 sorts (or “clusters”) the M constraint configurations based on the WL hashes of the M x N geometric variations for the 2D CAD drawing. For example, in some embodiments, for each of the M constraint configurations received or generated in step 201, a total of N WL hashes are computed. However, in practice many of the N WL hashes for a particular constraint configuration have the same value, indicating that some of the geometric variations for the particular constraint configuration are isomorphic. Thus, certain constraint configurations have many fewer WL hash values than N. This is particularly true for constraint configurations that correspond to a more highly constrained version of the 2D CAD drawing.

According to some embodiments, constraint configurations that have an identical set of WL hash values associated therewith are grouped together into a single cluster in step 207. This is because such constraint configurations can be assumed to be isomorphic. Then, from each such cluster of isomorphically identical constraint configurations, a single representative constraint configuration is selected and provided to user 101. As a result, user 101 is not provided with any isomorphically identical constraint configurations for a particular 2D CAD drawing. Thus, the number of constraint configurations to be evaluated by user 101 is reduced by preventing user 101 from evaluating multiple isomorphically identical constraint configurations.

In some embodiments, constraint configurations that share some but not all WL hash values are grouped together into a single cluster in step 207. For example, in one embodiment, constraint configurations that share a predetermined number of WL hash values are grouped together into a single cluster. This is because such constraint configurations can be assumed to be isomorphically similar. Then, from each such isomorphically similar cluster, a single representative constraint configuration is selected and provided to user 101. As a result, user 101 is provided with one representative constraint configuration from each family of isomorphically similar constraint configurations for a particular 2D CAD drawing. Thus, the number of constraint configurations to be evaluated by user 101 can be reduced by preventing user 101 from evaluating all N constraint configurations.

In step 208, constraint configuration clustering algorithm 130 displays (or causes to be displayed) one representative constraint configuration for each cluster of constraint configurations formed in step 207. For example, each representative constraint configuration can be displayed via UI 110. In some embodiments, user 101 can focus on a single cluster of constraint configurations when one representative constraint configuration is evaluated to retain the design intent of user 101 for the 2D CAD drawing generated prior to step 201. In such embodiments, selection by user 101 of a particular representative constraint configuration enables user 101 to further evaluate some or all constraint configurations in the cluster that includes the particular representative constraint configuration. In this way, user 101 can search for a constraint configuration that has the desired behavior of the particular representative constraint configuration but has fewer dimensions or is otherwise less complex than the particular representative constraint configuration.

### Selection of a Constraint Configuration Based on a WL Hash Value

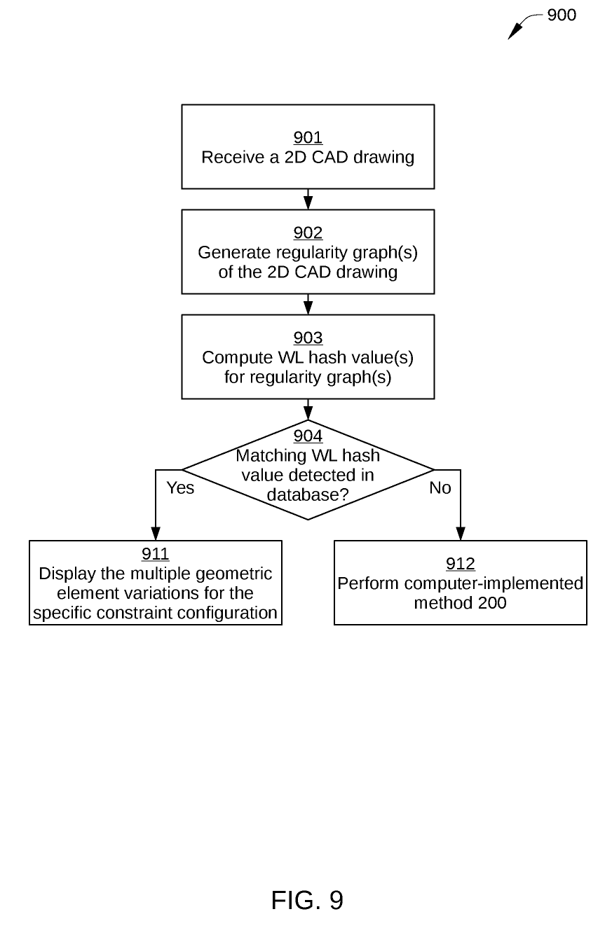

In some embodiments, rather than prompting a constraint solver to generate a plurality of constraint configurations for a 2D CAD drawing and then evaluating representative constraint configurations from the plurality so generated, a suitable constraint configuration for a 2D CAD drawing can be selected based on a WL hash value. In such embodiments, a WL hash value associated with the 2D CAD drawing is compared to stored WL hash values that are associated with previously evaluated constraint configurations, such as previously evaluated constraint configurations 151 in FIG. 1. One such embodiment is described below in conjunction with FIG. 9.

FIG. 9 sets forth a flowchart of method steps for selecting a constrained CAD drawing based on a hash value, according to various embodiments. Although the method steps are described in conjunction with the system of FIG. 1, persons skilled in the art will understand that any suitable system configured to perform the method steps, in any order, is within the scope of the embodiments.

A computer-implemented method 900 begins at step 901, where constraint configuration clustering system 100 receives a 2D CAD drawing. For example, the 2D CAD drawing can be generated by CAD program 120 or provided to constraint configuration clustering system 100 via UI 110 as an input 102.

In step 902, constraint configuration clustering algorithm 130 generates a regularity graph of the 2D CAD drawing. Alternatively, in some embodiments, constraint configuration clustering algorithm 130 generates a plurality of regularity graphs for the 2D CAD drawing by varying one or more dimensions of the 2D CAD drawing.

In step 903, constraint configuration clustering algorithm 130 computes a WL hash value for the regularity graph generated in step 902. In embodiments in which a plurality of regularity graphs are generated in step 902, constraint configuration clustering algorithm 130 generates a WL hash value for each regularity graph generated for the 2D CAD drawing. In some embodiments, a hash of WL hashes can then be computed. The hash of WL hashes is a hash of the multiple WL hash values generated for the plurality of regularity graphs associated with the 2D CAD drawing received in step 901. More specifically, the list of WL hashes from the plurality of regularity graphs are first sorted lexicographically and then concatenated and hashed to create the hash of WL hashes for a particular regularity graph. In this way, a single hash value is associated with the 2D CAD drawing received in step 901 rather than a set of multiple WL hash values. Similarly, a single hash value can be associated with each different previously evaluated constraint configuration 151 stored in constraint configuration database 150, rather than a set of multiple WL hash values that are generated in computer-implemented method 200.

In step 904, constraint configuration clustering algorithm 130 determines whether the WL hash value (or the hash of WL hashes) computed in step 903 matches any WL hash value 152 stored in constraint configuration database 150. If yes, computer-implemented method 900 proceeds to step 911; if no, computer-implemented method 900 proceeds to step 912.

In step 911, constraint configuration clustering algorithm 130 displays the previously evaluated constraint configuration 151 associated with the hash value 152 that matches the WL hash value computed in step 903. Because the previously evaluated constraint configuration 151 has a hash value 152 that matches the WL hash value computed for the 2D CAD drawing received in step 901, previously evaluated constraint configuration 151 is likely to be isomorphically identical to the 2D CAD drawing. Thus, a constraint configuration is provided to user 101 that is likely to match the design intent of the 2D CAD drawing without the need to perform the computations included in computer-implemented method 200.

In step 912, constraint configuration clustering algorithm 130 performs computer-implemented method 200. Step 912 is performed in response to the WL hash value for the 2D CAD drawing not matching any hash value 152 in constraint configuration database 150.

### Exemplary Computing Device

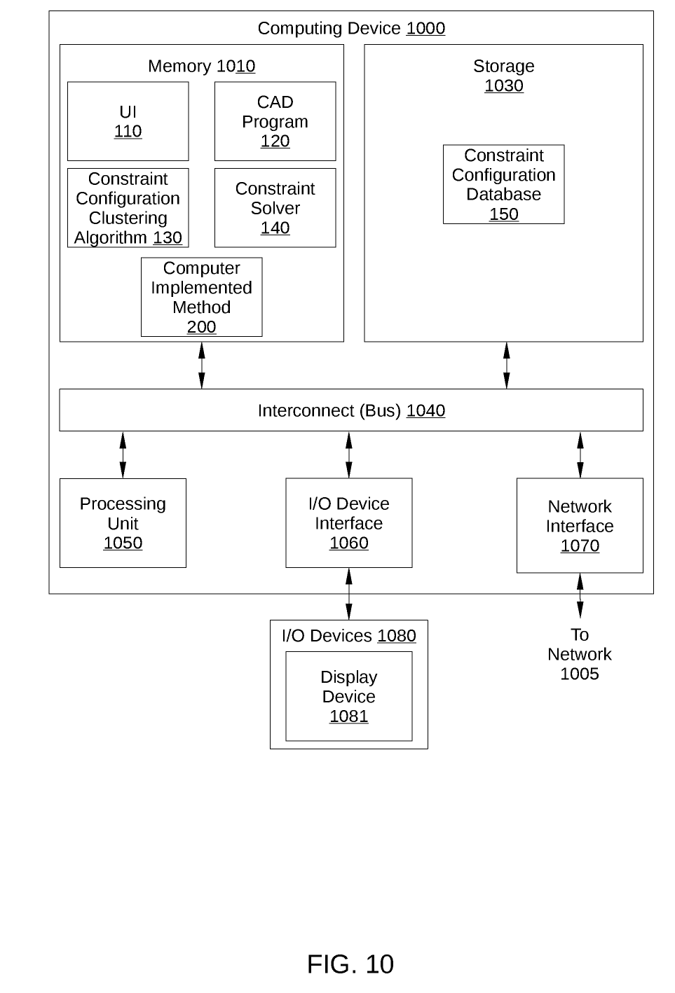

FIG. 10 is a block diagram of a computing device 1000 configured to implement one or more aspects of the various embodiments. Computing device 1000 may be a desktop computer, a laptop computer, a tablet computer, or any other type of computing device configured to receive input, process data, generate control signals, and display images. Computing device 1000 is configured to perform operations associated with UI 110, CAD program 120, constraint configuration clustering algorithm 130, constraint solver 140, constraint configuration database 150, computer-implemented method 200, computer-implemented method 900, and/or other suitable software applications, which can reside in a memory 1010. It is noted that the computing device described herein is illustrative and that any other technically feasible configurations fall within the scope of the present disclosure.

As shown, computing device 1000 includes, without limitation, an interconnect (bus) 1040 that connects a processing unit 1050, an input/output (I/O) device interface 1060 coupled to input/output (I/O) devices 1080, memory 1010, a storage 1030, and a network interface 1070. Processing unit 1050 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU. In general, processing unit 1050 may be any technically feasible hardware unit capable of processing data and/or executing software applications, including processes associated with UI 110, CAD program 120, constraint configuration clustering algorithm 130, constraint solver 140, constraint configuration database 150, computer-implemented method 200 and/or computer-implemented method 900. Further, in the context of the present disclosure, the computing elements shown in computing device 1000 may correspond to a physical computing system (e.g., a system in a data center) or may be a virtual computing instance executing within a computing cloud.

I/O devices 1080 may include devices capable of providing input, such as a keyboard, a mouse, a touch-sensitive screen, and so forth, as well as devices capable of providing output, such as a display device 1081. Additionally, I/O devices 1080 may include devices capable of both receiving input and providing output, such as a touchscreen, a universal serial bus (USB) port, and so forth. I/O devices 1080 may be configured to receive various types of input from an end-user of computing device 1000 and to also provide various types of output to the end-user of computing device 1000, such as one or more graphical user interfaces (GUI), displayed digital images, and/or digital videos. In some embodiments, one or more of I/O devices 1080 are configured to couple computing device 1000 to a network 1005.

Memory 1010 may include a random access memory (RAM) module, a flash memory unit, or any other type of memory unit or combination thereof. Processing unit 1050, I/O device interface 1060, and network interface 1070 are configured to read data from and write data to memory 1010. Memory 1010 includes various software programs that can be executed by processing unit 1050 and application data associated with said software programs, including UI 110, CAD program 120, constraint configuration clustering algorithm 130, constraint solver 140, constraint configuration database 150, computer-implemented method 200 and/or computer-implemented method 900.

In sum, the various embodiments described herein facilitate the selection of a constraint configuration for a particular 2D CAD drawing, for example from a plurality of suggested constraint configurations that are provided by a constraint solver.

In the embodiments, a constraint configuration clustering algorithm receives a first plurality of constrained CAD drawings that have been generated for a 2D CAD drawing of interest, generates a plurality of geometric variations of the 2D CAD drawing, and then generates a regularity graph for each geometric variation of the 2D CAD drawing. Each regularity graph represents geometric regularities between geometric elements included in a corresponding geometric variation, such as the presence of horizontally or vertically aligned points, horizontally or vertically aligned lines, arcs or circles having equal radii, lines that are parallel to each other, lines that are perpendicular to each other, and arcs or circles that are concentrically positioned. The constraint configuration clustering algorithm then sorts (or “clusters”) the geometric variations based on the regularity graphs to generate a plurality of filtered constrained CAD drawings that are grouped in clusters. In some embodiments, the constraint configuration clustering algorithm filters the geometric variations by applying a Weisfeiler-Lehman hash to the regularity graphs.

At least one technical advantage of the disclosed techniques relative to the prior art is that the disclosed techniques provide a designer or other user with constraint configurations for a specific 2D CAD drawing, where each constraint configuration causes the 2D CAD drawing to scale in a different way. Thus, a user can select a constraint configuration from a wide range of options that parameterize the 2D CAD drawing in a variety of ways and is not forced to evaluate many constraint configurations that are isometrically identical to one another. Consequently, the user is more likely to identify a constraint configuration that fully captures the design intent of the 2D CAD drawing. Another advantage is that processing resources are more efficiently utilized in providing a suitable constraint configuration to a user. Such efficiency arises because the disclosed techniques provide automated mechanisms for providing a selection of constraint configurations, where each constraint configuration is more likely to cause the 2D CAD drawing to scale differently when parametric values are modified. Therefore, repeated computation to generate additional constraint configurations can be avoided. Further, in some embodiments, the use of a previously evaluated constraint configuration can be employed for a 2D CAD drawing in lieu of generating and evaluating a plurality of constraint configurations. In such embodiments, a cached constraint configuration that is topologically equivalent to the 2D CAD drawing can be employed for the 2D CAD drawing, thereby avoiding the computations needed to generate a plurality of new constraint configurations for the 2D CAD drawing with a constraint solver. These technical advantages provide one or more technological advancements over prior art approaches.

1. In some embodiments, a computer-implemented method for grouping constrained computer-aided design (CAD) drawings includes: receiving a plurality of constrained CAD drawings; generating a plurality of geometric variations, wherein each geometric variation in the plurality of geometric variations is based on one of the constrained CAD drawings in the plurality of constrained CAD drawings; generating, for each geometric variation included in the plurality of geometric variations, a regularity graph that represents geometric regularities between a plurality of geometric elements included in the geometric variation; sorting the geometric variations based on the regularity graphs to generate a plurality of filtered constrained CAD drawings; and displaying, via a user interface, the plurality of filtered constrained CAD drawings.

2. The computer-implemented method of clause 1, wherein each geometric variation in the plurality of geometric variations comprises a representation of the plurality of geometric elements in which a value for at least one dimension associated with a particular geometric element included in the plurality of geometric elements is changed from an initial value to a scaled value.

3. The computer-implemented method of clauses 1 or 2, wherein the at least one dimension associated with the particular geometric element comprises at least one of a length of the particular geometric element, a radius of the particular geometric element, a vertical position within the CAD drawing of a point on the particular geometric element, or a horizontal position within the CAD drawing of the point on the particular geometric element.

4. The computer-implemented method of any of clauses 1-3, wherein the geometric variations are filtered by applying a Weisfeiler-Lehman hash against the regularity graphs.

5. The computer-implemented method of any of clauses 1-4, wherein applying the Weisfeiler-Lehman hash against the regularity graphs comprises: computing a Weisfeiler-Lehman hash for each regularity graph; determining that a subset of the regularity graphs share at least one hash value; and grouping the subset of the regularity graphs into a single cluster.

6. The computer-implemented method of any of clauses 1-5, wherein each constrained CAD drawing included in the plurality of constrained CAD drawings includes at least one geometric element that comprises at least one of a line, a curve, a point, a constraint, or a dimension.

7. The computer-implemented method of any of clauses 1-6, wherein generating the regularity graph for each geometric variation included in the plurality of geometric variations comprises including a vertex in the regularity graph for each geometric element in the geometric variation.

8. The computer-implemented method of any of clauses 1-7, wherein generating the regularity graph for each geometric variation included in the plurality of geometric variations comprises including an edge in the regularity graph indicating a pair of geometric elements in the geometric variation are connected to each other.

9. The computer-implemented method of any of clauses 1-8, wherein generating the regularity graph for each geometric variation included in the plurality of geometric variations comprises including a vertex in the regularity graph for each geometric regularity detected in the geometric variation.

10. The computer-implemented method of any of clauses 1-9, wherein the geometric regularity comprises one of multiple horizontally aligned points in the geometric variation, multiple vertically aligned points in the geometric variation, multiple horizontally aligned lines in the geometric variation, multiple vertically aligned lines in the geometric variation, an equal radius for multiple arcs or circles in the geometric variation, multiple parallel lines in the geometric variation, a pair of perpendicular lines in the geometric variation, multiple concentric arcs or circles in the geometric variation, a tangency of a line to an arc or circle in the geometric variation, a pair of equidistant point-to-point distances in the geometric variation, or a pair of equidistant point-to-line distances in the geometric variation.

11. The computer-implemented method of any of clauses 1-10, further comprising: prior to receiving the plurality of constrained CAD drawings, receiving a 2D CAD drawing; generating at least one regularity graph of the 2D CAD drawing; computing a Weisfeiler-Lehman hash for the at least one regularity graph of the 2D CAD drawing; and selecting a previously evaluated constraint configuration for the 2D CAD drawing based on the Weisfeiler-Lehman hash for the at least one regularity graph of the 2D CAD drawing.

12. The computer-implemented method of any of clauses 1-11, wherein the plurality of filtered constrained CAD drawings includes one representative constraint configuration from each of a plurality of clusters of similar constraint configurations.

13. In some embodiments, a non-transitory computer readable medium includes a set of instructions which, in response to execution by a processor of a computer system, cause the processor to perform the steps of: receiving a plurality of constrained CAD drawings; generating a plurality of geometric variations, wherein each geometric variation in the plurality of geometric variations is based on one of the constrained CAD drawings in the plurality of constrained CAD drawings; generating, for each geometric variation included in the plurality of geometric variations, a regularity graph that represents geometric regularities between a plurality of geometric elements included in the geometric variation; sorting the geometric variations based on the regularity graphs to generate a plurality of filtered constrained CAD drawings; and displaying, via a user interface, the plurality of filtered constrained CAD drawings.

14. The non-transitory computer readable medium of clause 13, wherein each geometric variation in the plurality of geometric variations comprises a representation of the plurality of geometric elements in which a value for at least one dimension associated with a particular geometric element included in the plurality of geometric elements is changed from an initial value to a scaled value.

15. The non-transitory computer readable medium of clauses 13 or 14, wherein the at least one dimension associated with the particular geometric element comprises at least one of a length of the particular geometric element, a radius of the particular geometric element, a vertical position within the CAD drawing of a point on the particular geometric element, or a horizontal position within the CAD drawing of the point on the particular geometric element.

16. The non-transitory computer readable medium of any of clauses 13-15, wherein the geometric variations are filtered by applying a Weisfeiler-Lehman hash against the regularity graphs.

17. The non-transitory computer readable medium of any of clauses 13-16, wherein applying the Weisfeiler-Lehman hash against the regularity graphs comprises: computing a Weisfeiler-Lehman hash for each regularity graph; determining that a subset of the regularity graphs share at least one hash value; and grouping the subset of the regularity graphs into a single cluster.

18. The non-transitory computer readable medium of any of clauses 13-17, wherein each constrained CAD drawing included in the plurality of constrained CAD drawings includes at least one geometric element that comprises at least one of a line, a curve, a point, a constraint, or a dimension.

19. The non-transitory computer readable medium of any of clauses 13-18, wherein generating the regularity graph for each geometric variation included in the plurality of geometric variations comprises including a vertex in the regularity graph for each geometric element in the geometric variation.

20. In some embodiments, a system includes: a memory that stores instructions; and a processor that is communicatively coupled to the memory and is configured to, when executing the instructions, perform the steps of: receiving a plurality of constrained CAD drawings; generating a plurality of geometric variations, wherein each geometric variation in the plurality of geometric variations is based on one of the constrained CAD drawings in the plurality of constrained CAD drawings; generating, for each geometric variation included in the plurality of geometric variations, a regularity graph that represents geometric regularities between a plurality of geometric elements included in the geometric variation; sorting the geometric variations based on the regularity graphs to generate a plurality of filtered constrained CAD drawings; and displaying, via a user interface, the plurality of filtered constrained CAD drawings.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for grouping constrained computer-aided design (CAD) drawings, the method comprising:
receiving a plurality of constrained CAD drawings;
generating a plurality of geometric variations, wherein each geometric variation in the plurality of geometric variations is based on one of the constrained CAD drawings in the plurality of constrained CAD drawings;
generating, for each geometric variation included in the plurality of geometric variations, a regularity graph that represents geometric regularities between a plurality of geometric elements included in the geometric variation;
sorting the geometric variations based on the regularity graphs to generate a plurality of filtered constrained CAD drawings; and
displaying, via a user interface, the plurality of filtered constrained CAD drawings.

2. The computer-implemented method of claim 1, wherein each geometric variation in the plurality of geometric variations comprises a representation of the plurality of geometric elements in which a value for at least one dimension associated with a particular geometric element included in the plurality of geometric elements is changed from an initial value to a scaled value.

3. The computer-implemented method of claim 2, wherein the at least one dimension associated with the particular geometric element comprises at least one of a length of the particular geometric element, a radius of the particular geometric element, a vertical position within the CAD drawing of a point on the particular geometric element, or a horizontal position within the CAD drawing of the point on the particular geometric element.

4. The computer-implemented method of claim 1, wherein the geometric variations are filtered by applying a Weisfeiler-Lehman hash against the regularity graphs.

5. The computer-implemented method of claim 4, wherein applying the Weisfeiler-Lehman hash against the regularity graphs comprises:
computing a Weisfeiler-Lehman hash for each regularity graph;
determining that a subset of the regularity graphs share at least one hash value; and
grouping the subset of the regularity graphs into a single cluster.

6. The computer-implemented method of claim 1, wherein each constrained CAD drawing included in the plurality of constrained CAD drawings includes at least one geometric element that comprises at least one of a line, a curve, a point, a constraint, or a dimension.

7. The computer-implemented method of claim 1, wherein generating the regularity graph for each geometric variation included in the plurality of geometric variations comprises including a vertex in the regularity graph for each geometric element in the geometric variation.

8. The computer-implemented method of claim 1, wherein generating the regularity graph for each geometric variation included in the plurality of geometric variations comprises including an edge in the regularity graph indicating a pair of geometric elements in the geometric variation are connected to each other.

9. The computer-implemented method of claim 1, wherein generating the regularity graph for each geometric variation included in the plurality of geometric variations comprises including a vertex in the regularity graph for each geometric regularity detected in the geometric variation.

10. The computer-implemented method of claim 9, wherein the geometric regularity comprises one of multiple horizontally aligned points in the geometric variation, multiple vertically aligned points in the geometric variation, multiple horizontally aligned lines in the geometric variation, multiple vertically aligned lines in the geometric variation, an equal radius for multiple arcs or circles in the geometric variation, multiple parallel lines in the geometric variation, a pair of perpendicular lines in the geometric variation, multiple concentric arcs or circles in the geometric variation, a tangency of a line to an arc or circle in the geometric variation, a pair of equidistant point-to-point distances in the geometric variation, or a pair of equidistant point-to-line distances in the geometric variation.

11. The computer-implemented method of claim 1, further comprising;
prior to receiving the plurality of constrained CAD drawings, receiving a 2D CAD drawing;
generating at least one regularity graph of the 2D CAD drawing;
computing a Weisfeiler-Lehman hash for the at least one regularity graph of the 2D CAD drawing; and
selecting a previously evaluated constraint configuration for the 2D CAD drawing based on the Weisfeiler-Lehman hash for the at least one regularity graph of the 2D CAD drawing.

12. The computer-implemented method of claim 1, wherein the plurality of filtered constrained CAD drawings includes one representative constraint configuration from each of a plurality of clusters of similar constraint configurations.

13. A non-transitory computer readable medium that includes a set of instructions which, in response to execution by a processor of a computer system, cause the processor to perform the steps of:
receiving a plurality of constrained CAD drawings;
generating a plurality of geometric variations, wherein each geometric variation in the plurality of geometric variations is based on one of the constrained CAD drawings in the plurality of constrained CAD drawings;
generating, for each geometric variation included in the plurality of geometric variations, a regularity graph that represents geometric regularities between a plurality of geometric elements included in the geometric variation;
sorting the geometric variations based on the regularity graphs to generate a plurality of filtered constrained CAD drawings; and
displaying, via a user interface, the plurality of filtered constrained CAD drawings.

14. The non-transitory computer readable medium of claim 13, wherein each geometric variation in the plurality of geometric variations comprises a representation of the plurality of geometric elements in which a value for at least one dimension associated with a particular geometric element included in the plurality of geometric elements is changed from an initial value to a scaled value.

15. The non-transitory computer readable medium of claim 14, wherein the at least one dimension associated with the particular geometric element comprises at least one of a length of the particular geometric element, a radius of the particular geometric element, a vertical position within the CAD drawing of a point on the particular geometric element, or a horizontal position within the CAD drawing of the point on the particular geometric element.

16. The non-transitory computer readable medium of claim 13, wherein the geometric variations are filtered by applying a Weisfeiler-Lehman hash against the regularity graphs.

17. The non-transitory computer readable medium of claim 16, wherein applying the Weisfeiler-Lehman hash against the regularity graphs comprises:
computing a Weisfeiler-Lehman hash for each regularity graph;
determining that a subset of the regularity graphs share at least one hash value; and
grouping the subset of the regularity graphs into a single cluster.

18. The non-transitory computer readable medium of claim 13, wherein each constrained CAD drawing included in the plurality of constrained CAD drawings includes at least one geometric element that comprises at least one of a line, a curve, a point, a constraint, or a dimension.

19. The non-transitory computer readable medium of claim 13, wherein generating the regularity graph for each geometric variation included in the plurality of geometric variations comprises including a vertex in the regularity graph for each geometric element in the geometric variation.

20. A system, comprising:
a memory that stores instructions; and
a processor that is communicatively coupled to the memory and is configured to, when executing the instructions, perform the steps of:
receiving a plurality of constrained CAD drawings;
generating a plurality of geometric variations, wherein each geometric variation in the plurality of geometric variations is based on one of the constrained CAD drawings in the plurality of constrained CAD drawings;
generating, for each geometric variation included in the plurality of geometric variations, a regularity graph that represents geometric regularities between a plurality of geometric elements included in the geometric variation;
sorting the geometric variations based on the regularity graphs to generate a plurality of filtered constrained CAD drawings; and
displaying, via a user interface, the plurality of filtered constrained CAD drawings.
